(19) United States
(12) Patent Application Publication
(10) Pub. No.: US 2025/0385972 A1
(43) Pub. Date: Dec. 18, 2025

(54) CONCURRENT ACCESS OF SHARED BALANCE ACCOUNT IN CHARGING SYSTEMS

(71) Applicant: Telefonaktiebolaget LM Ericsson (publ), Stockholm (SE)

(72) Inventor: Ramanathan OPPILAMANI, Chennai (IN)

(21) Appl. No.: 18/878,318

(22) PCT Filed: Jun. 30, 2022
(86) PCT No.: PCT/IN2022/050599

§ 371 Date: Dec. 23, 2024

(51) Int. Cl. H04M 15/00; H04W 4/24

(52) U.S. Cl. CPC H04M 15/781; H04M 15/64; H04W 4/24

(57) ABSTRACT

Embodiments of the present disclosure provide a method for control of balance account access to a balance account, the method being performed by a network node in a wireless communication network. The method includes receiving requests for accessing the balance account. The method includes determining whether there are a plurality of requests for accessing the balance account. Upon determination that there are a plurality of requests for access of the balance account, the method includes deciding to split the balance account into one or more sub-balances. The method includes redirecting the plurality of requests to access the one or more sub-balances. Corresponding network node, online charging system, OCS, and computer program products are also disclosed.

### TECHNICAL FIELD

The present disclosure relates generally to the field of online charging systems. More particularly, it relates to method, network node, online charging system, and computer program products for concurrent access of shared balance account in online charging systems.

### BACKGROUND

Mobile devices are increasingly used to perform various functions such as streaming multimedia content, playing high-definition online games, enabling video calls, and so forth in addition to basic voice calls. Each of these functions require network resources. It is therefore important to efficiently and effectively charge such communication sessions to provide optimized network services.

There exists an Online Charging System, OCS, which can be used to efficiently and effectively charge the communication sessions and provide the optimized network services to consumers.

The OCS provides a facility of charging the consumer in real-time based on a service used by the consumer. In addition, the OCS provides a facility of pre-hand charging the consumer based on the services to be used. The OCS maintains a balance account, which can be accessed by the consumers for performing the one or more functions. The balance account is accessed using service requests by the consumers.

The OCS comprises a network node, for example a Balance Management Function, BMF, for controlling of a balance account access to the balance account upon receiving the service requests from the consumers. The BMF receives the service requests from the consumers in parallel for accessing the balance account. However, the BMF allows only one request to update the balance account at time. Thus, a wait time for the other requests increases linearly based on a number of service requests received for accessing the balance account.

FIG. 1 illustrates an existing implementation of the OCS for controlling the access to the balance account.

As depicted in FIG. 1, an OCS 110 comprises an Online Charging Function, OCF 108, a Charging Core, CHA core 106 and a BMF 104. The BMF 104 may be termed as the network node as explained above. The BMF 104 comprises a container 204, wherein the balance account is stored and updated.

A Charging Trigger Function, CTF, 206 receives the service requests, for example, Credit Control Requests, CCRs for accessing the balance account. The CTF 206 connects to the OCS 110 through the OCF 108 and forwards the service requests to the CHA core 106 of the OCS 110 through the OCF 108. The CHA core 106 analyses the service requests and sends the service requests in parallel to the BMF 104 as depicted in FIG. 1.

Upon receiving the service requests, the BMF 104 processes each service request/CCR update request at a time and updates the balance account. For example, if the BMF 104 receives “N” number of service requests for accessing the balance account comprising a balance amount “B”, wherein the “N” may be 8 CCRs, for example, CCR update 1 to CCR update 8, and the balance “B” may be 100 USD, as depicted in FIG. 1. Upon receiving the CCR updates 1-8, the BMF 104 processes each CCR update at a time and updates the balance account. Therefore, when the “N” number of concurrent requests (CCR update 1-CCR update 8) are accessing the balance “B”, each request has a wait time before it can update the balance account. When the balance account is updated by only one service request/CCR update at a time, the other requests need to wait in a queue. For instance, if an update of the balance account after processing of one service request takes one second, sec, per update, and if there are eight concurrent service requests, as depicted in FIG. 1, then a maximum, max, wait time of the concurrent service requests can be 8 seconds. Further, as the number of concurrent requests increases, the max wait time of the service requests also increases. A primary reason for the increased wait time is that all service requests are trying to access and update same balance “B”, while only one service request alone can update the balance account at a time.

### SUMMARY

With an increasing amount of consumers of communication sessions, there is also an increasing amount of users of Online Charging System, OCS, used to charge the communication sessions and provide the optimized network services to consumers.

A higher number of concurrent requests from consumers in a sharing scenario may be supported as long as the current balance account updates are supported. However, an issue with the current balance handling is that, the concurrent request handling is restricted by the limitation of concurrent balance account update, as the balance account cannot be updated in parallel. Thus, the service requests may not be scaled well with increase in the number of the concurrent service requests, as the Balance Management Function, BMF, of the OCS processes only one service request at a time.

Further, the Balance Management Function, BMF, used for controlling of a balance account access to the balance account upon receiving the service requests from the consumers BMFs is not able to provide a real-time limit control of the balance account when there are multiple concurrent service requests accessing the same balance account at a time. Thus, the wait time for reservation/deduction of/from the balance account for the service requests increases linearly based on the number of concurrent service requests received towards the balance account.

Consequently, there is a need for an improved method and arrangement for controlling a balance account being accessed by a plurality of requests in an Online Charging System, OCS that alleviates at least some of the above-cited problems.

It is therefore an object of the present disclosure to provide a method, a network node, a system, and a computer program product for controlling of balance account access to a balance account, to mitigate, alleviate, or eliminate all or at least some of the above-discussed drawbacks of presently known solutions.

This and other objects are achieved by means of a method, a network node, a system, and a computer program product as defined in the appended claims. The term exemplary is in the present context to be understood as serving as an instance, example or illustration.

According to a first aspect of the present disclosure, a method for control of balance account access to a balance account is provided. The method being performed by a network node in a wireless communication network. The method comprises receiving requests for accessing the balance account. The method comprises determining whether there are a plurality of requests for accessing the balance account. Upon determination that there are a plurality of requests for access of the balance account, the method comprises deciding to split the balance account into one or more sub-balances. The method comprises redirecting the plurality of requests to access the one or more sub-balances concurrently.

In some embodiments, the method further comprises creating one or more sub-containers with the one or more sub-balances and storing information comprising a mapping of the split of the balance account with the one or more sub-containers.

In some embodiments, the step of deciding to split the balance account into the one or more sub-balances comprises obtaining an average wait time interval for deducting the balance account for each of the plurality of requests. The method further comprises determining the number of requests accessing the balance account and deciding to split the balance account into the one or more sub-balances based on the average wait time interval and the determined number of requests.

In some embodiments, the step of redirecting the plurality of requests to access the one or more sub-balances in accordance with the split of the balance account comprises determining the sub-balance in each of the sub-container. The method further comprises assigning one or more requests among the plurality of requests to each sub-container for accessing the balance account.

In some embodiments, the method further comprises merging the one or more sub-balances in each of the sub-containers into a single balance account.

In some embodiments, the step of merging the sub-balances into a single balance account comprises determining the number of requests accessing the balance account. Based on the determined number of requests, the method comprises merging the sub-balances into the single balance account based on the determined number of requests.

In some embodiments, the step of merging the sub-balances into the single balance account comprises determining that a sub-balance in one of the sub-containers is not fulfilling a required balance account for a request, and merging the one or more sub-balances in each of the sub-containers. The method further comprises distributing the merged sub-balances to each of the sub-containers and determining whether a sub-balance in any of the sub-containers is not fulfilling a configured value of the balance account for each container. When it has been determined that the sub-balance in any of the sub-containers is not fulfilling the configured value of the balance account for the sub-container, the method comprises merging the sub-balances into a single balance account within a single container. In some embodiments, the method further comprises auto-rebalancing the one or more sub-balances in each of the sub-containers.

In some embodiments, the step of auto-rebalancing the one or more sub-balances in each of the sub-containers comprises determining that at least one sub-container, from the one or more sub-containers is empty and auto-rebalancing the one or more sub-balances in each of the sub-containers.

According to a second aspect of the present disclosure, a network node for controlling balance account access to a balance account is provided. The network node comprises a processor, and a memory storing instructions that, when executed by the processor, cause the network node to receive requests for accessing a balance account. The network node is adapted to cause determination of whether there are a plurality of requests for accessing the balance account. Upon determination that there are a plurality of requests for access of the balance account, the network node is adapted to cause deciding to split the balance account into one or more sub-balances. The network node is adapted to cause redirection of the plurality of requests to access the one or more sub-balances.

According to a third aspect of the present disclosure, online charging system, OCS, operable to provide online charging for a session is provided. The OCS includes an online charging function, OCF, and a network node being adapted to control of balance account access to the balance account. The network node is adapted for receiving requests for accessing the balance account. The network node is adapted for determining whether there are a plurality of requests for accessing the balance account. Upon determination that there are a plurality of requests for access of the balance account, deciding to split the balance account into one or more sub-balances. The network node is adapted for redirecting the plurality of requests to access the one or more sub-balances.

According to a fourth aspect of the present disclosure, there is provided a computer program product comprising a non-transitory computer readable medium, having thereon a computer program comprising program instructions. The computer program is loadable into a data processing unit and configured to cause execution of the method according to first aspect when the computer program is run by the data processing unit.

In some embodiments, any of the above aspects may additionally have features identical with or corresponding to any of the various features as explained above for any of the other aspects.

An advantage of some embodiments is that alternative and/or improved approaches are provided for controlling the balance account upon receiving a plurality of service requests from the consumers.

An advantage of some embodiments is that the plurality of requests received by the OCS are concurrently processed.

An advantage of some embodiments is to enable splitting of the balance account into the one or more sub-balances and redirecting the plurality of requests to access the one or more sub-balances. As a result, the balance account is updated in parallel by concurrent processing of the plurality of requests.

An advantage of some embodiments is that concurrent balance account update in a shared scenario is achieved, thereby providing better utilization of the hardware resources, especially in Business 2 Business, B2B scenarios with sharing of resources.

An advantage of some embodiments is that real time control of the plurality of requests accessing the balance account is achieved.

An advantage of some embodiments is that splitting of the balance into the one or more sub-balances, so that each of the sub-balances can be updated independently by the received requests. As a result, a consolidated view of the balance account can be provided to the consumer.

An advantage of some embodiments is that the concurrency in balance management is increased, which further improves the capacity of online charging capability when the balance account is shared.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 illustrates an existing implementation of the OCS for controlling an access to the balance account;

FIG. 2 discloses a block diagram illustrating the OCS in a wireless communication network, according to some examples;

FIG. 3 is a flowchart illustrating example method steps, according to some examples;

FIGS. 4A-4C disclose an example implementation of the OCS for controlling access to the balance account, according to some examples

FIG. 5 is a schematic block diagram illustrating an example network node, according to some examples; and

FIG. 6 discloses an example computing environment, according to some examples.

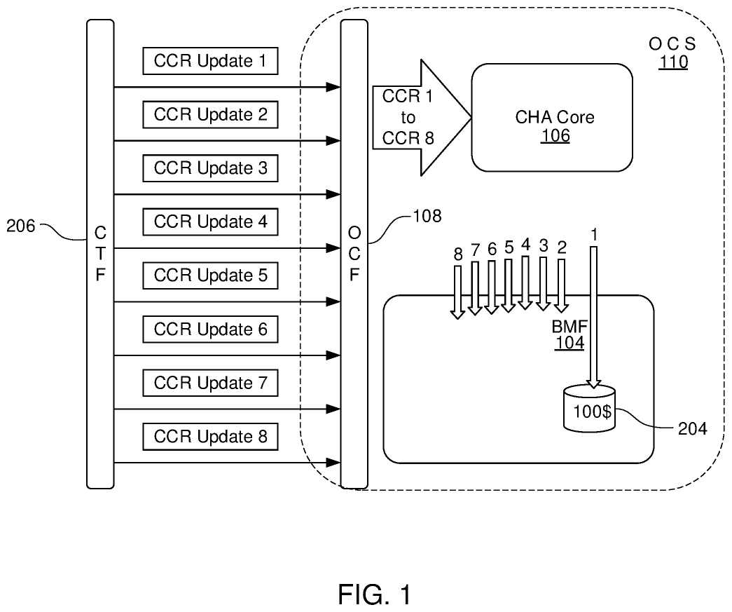

### DETAILED DESCRIPTION

Aspects of the present disclosure will be described more fully hereinafter with reference to the accompanying drawings. The network node and method disclosed herein can, however, be realized in many different forms and should not be construed as being limited to the aspects set forth herein. Like numbers in the drawings refer to like elements throughout.

The terminology used herein is for describing particular aspects of the disclosure only, and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the examples set forth herein.

It will be appreciated that when the present disclosure is described in terms of a method, it may also be embodied in one or more processors and one or more memories coupled to the one or more processors, wherein the one or more memories store one or more programs that perform the steps, services, and functions disclosed herein when executed by the one or more processors.

In the following description of examples, the same reference numerals denote the same or similar components.

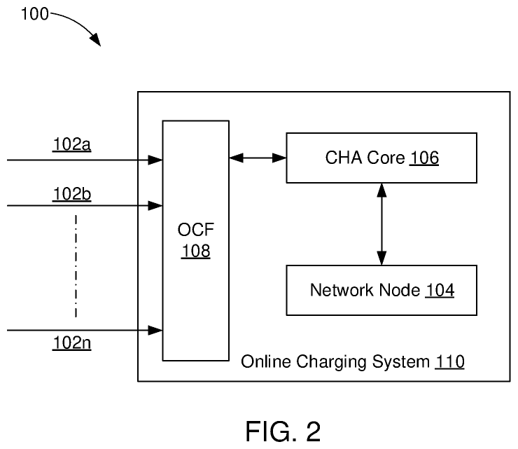

FIG. 2 discloses a block diagram illustrating a wireless communication network 100. Although the subject matter described herein may be implemented in any appropriate type of system using any suitable components, the examples disclosed herein are described in related to a wireless communication network, such as the example wireless communication network 100 described in FIG. 2.

The wireless communication network 100 may comprise and/or interface with any type of communication, telecommunication, data, cellular, and/or radio network or other similar type of system. In some examples, the wireless communication network 100 may be configured to operate according to specific standards or other types of predefined rules of procedures. Thus, the wireless communication network 100 may implement communication standards, such as, but are not limited to, global system for mobile communications, GSM, universal mobile telecommunications system, UMTS, long term evolution, LTE, and/or other suitable 2G, 3G, 4G, or 5G standards, wireless local area network, WLAN, standards such as, IEEE 802.11 standards, and/or any other appropriate wireless communication standards, such as, worldwide interoperability for microwave access, WiMax, Bluetooth, Z-Wave and/or ZigBee standards. The wireless communication network 100 may provide communication and other type of services to one or more wireless devices to facilitate the wireless devices access to and/or use of the services provided by, or via, the wireless communication network 100.

As depicted in FIG. 2, the wireless communication network 100 comprises an online charging system, OCS, 110. The OCS 110 referred herein may perform online charging to efficiently and effectively charge communication sessions and provide optimized network services to a consumer. In some examples, the online charging may involve monitoring a balance account requested by the consumer and granting access/slices from the balance account to network elements of the wireless communication network 100 to provide the network services/communication services to the consumer.

In some examples, the balance account (also be referred to as a resource account, a billing account, or the like) may be stored in at least one container and may indicate a credit/amount/balance available for reserving/deducting for the accessed communication services or for the communication services to be accessed. In some examples, the balance account may be a monetary account having a monetary balance. In some examples, the balance account may be a non-monetary account having a non-monetary balance. In some other examples, a network service provider/customer may have the balance account and may share the balance account with a plurality of consumers.

In some examples, the consumer (also be referred to as a user, a client, or the like) may be an end user attempting to access the balance account of the provider.

In some examples, the communication sessions (also be referred to as “sessions”) may be associated with the communication services such as, but are not limited to, voice calls, streaming multimedia services, online games, Internet Protocol Multimedia Subsystem, IP IMS sessions, and so on.

As depicted in FIG. 2, the OCS 110 comprises an Online Charging Function, OCF 108, a Charging Core, CHA core 106, and a network node 104.

The OCF 108 referred herein may be adapted to receive a plurality of requests 102a-102n from the consumers for accessing the balance account. The terms “requests”, “Credit Control Requests, CCRs”, “CCR updates”, “service requests”,and so on, are used interchangeably for a request used for accessing the balance account. The OCF 108 forwards the received requests to the CHA core 106.

The CHA core 106 may be adapted to pre-process the requests received from the OCF 108 and forwards the requests after the pre-processing to the network node 108.

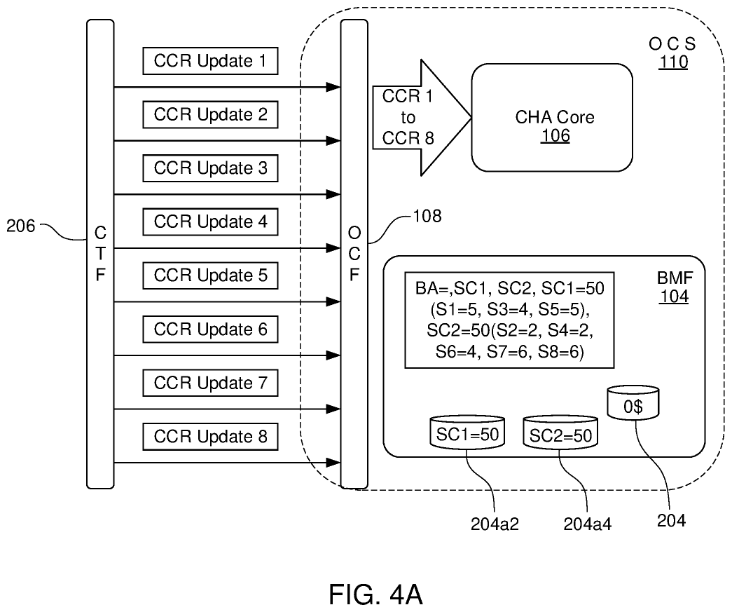

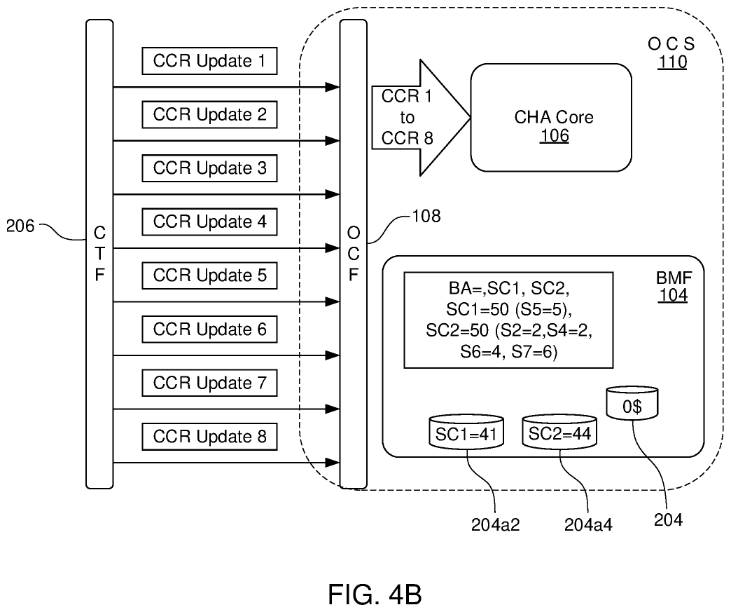

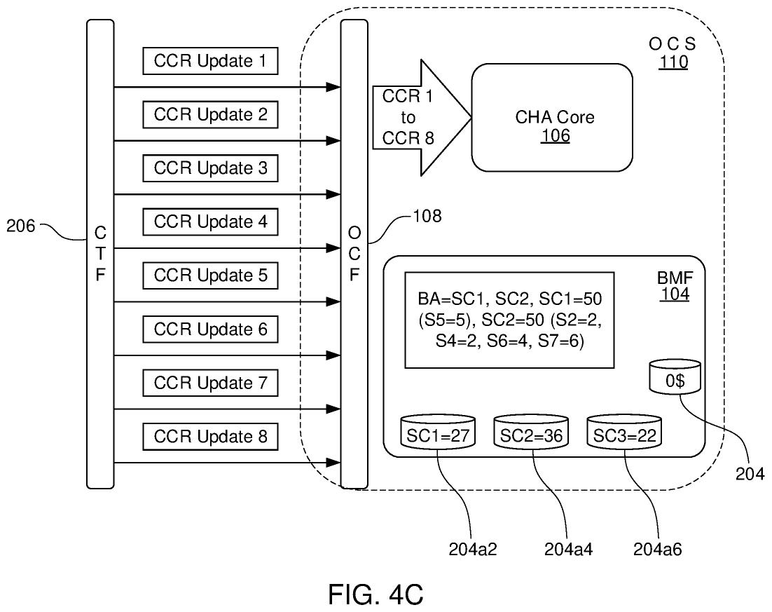

In some examples, the network node 104 refers to an equipment capable, configured, arranged, and/or operable to control of balance account access to the balance account. The network node 104 may also be referred to as Balance Management Function, BMF (as depicted in FIGS. 4A-4C).

The network node 104 may be adapted to receive the requests, for example, via the CHA core 106 and to update the balance account in line with the received requests. The requests may be received in parallel. In some exemplary solutions, upon receiving the requests in parallel, the network node 104 processes a single request at a time and updates the balance account, so that the balance account may be updated by only one request at a time. However, from processing of the single request at a time, other requests have to wait in a queue until processing of the previous requests. As a result, a wait time for each request can increase linearly with increased number of requests attempting to access the balance account. In addition, the network node 104 rejects a new request, when a number of requests present in the queue exceeds a pre-defined limit. Thus, in the exemplary solutions, concurrent request handling is restricted by limitation of concurrent balance update.

Therefore, the present disclosure, the network node 104 implements an improved method for control of the balance account access to the balance account, which balance account characteristically is capable of being updated by one request at a time.

The network node 104 receives requests for accessing the balance account. The network node 104 determines whether there are a plurality of requests for accessing the balance account. Upon determination that there are the plurality of requests for accessing the balance account, the network node 104 decides to split the balance account into one or more sub-balances. The network node 104 redirects the plurality of requests to access the one or more sub-balances.

Optionally, the network node 104 may also create one or more sub-containers which represent a memory or a storage arranged to store the one or more sub-balances and to store information comprising a mapping of the split of the balance account with the one or more sub-containers.

Thus, concurrent balance update in a shared scenario, i.e., the plurality of requests is being attempting to access the balance account, may be achieved with better utilization of network resources and real time limit control.

Various examples for control of the balance access requests to the balance account are explained in conjunction with figures in the later parts of the description.

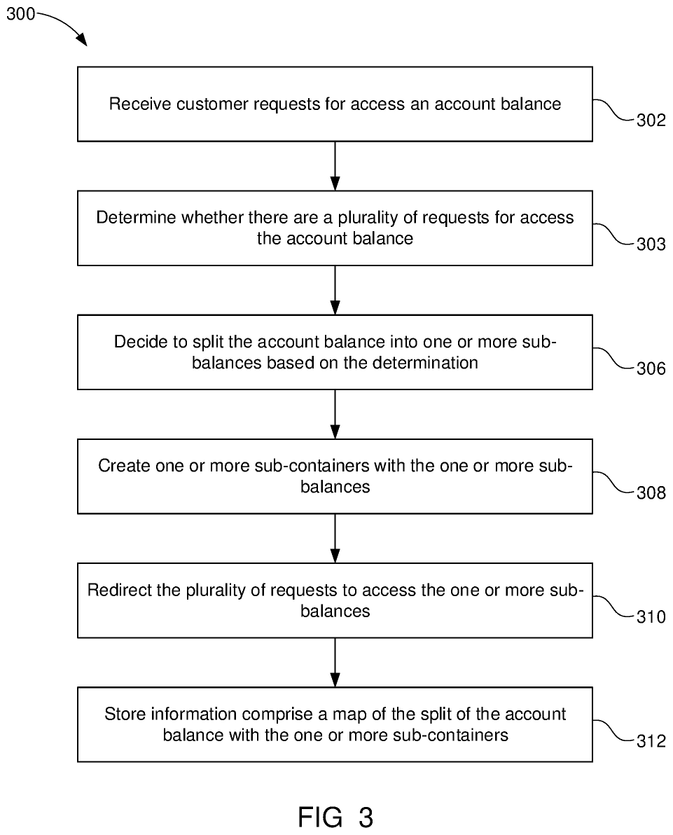

FIG. 3 is a flowchart illustrating example method steps of a method 300 performed by the network node within the OCS.

At step 302, the method 300 comprises receiving requests for accessing the balance account. In some examples, the network node may receive the requests from the CHA core. The balance account is stored in a container of the OCS may indicate a credit/balance available for reserving/deducting towards at least one communication session being consumed or to be consumed by the consumer.

At step 304, after receiving the requests, the method 300 comprises determining whether there are a plurality of requests for accessing the balance account.

In some examples, determining whether there are the plurality of requests for accessing the balance account may comprise determining that there exist a plurality of requests for accessing the balance account from more than one consumer.

At step 306, the method 300 comprises deciding to split the balance account into one or more sub-balances upon determination that there are plurality of requests for accessing the balance account.

The step of 306 of deciding to split the balance account into one or more sub-balances may comprise obtaining an average wait time interval for deducting the balance account for each of the plurality requests.

In some examples, the average wait time interval for deducting the balance account for each of the plurality requests is obtained based on a maximum wait time, an allowed wait time, and a processing time of each request. In some examples, the maximum wait time is the time required for processing of all requests attempting to access the balance account. In some examples, the allowed wait time represents the wait time above which, the request attempting to access the balance account may be rejected. The allowed wait time is explained in detail in conjunction with FIGS. 4A-4C. In some examples, the processing time denotes the time required for processing the single request accessing the balance account.

Upon obtaining the average wait time, the method comprises determining a number of requests accessing the balance account. Based on the average wait time interval and the determined number of requests, the method may comprise deciding to split the balance account into the one or more sub-balances.

In some examples, the step of deciding to split the balance account into the one or more sub-balances comprises determining whether the maximum wait time exceeds the allowed wait time. Upon determining that the maximum wait time exceeds the allowed wait time, the method comprises deciding to split the balance account into the one or more sub-balances.

The sub-balances may also be referred as one or balance accounts to be maintained in each sub-container. In some examples, the number of sub-balances may vary. In an example, the balance account may split into two sub-balances. In another example, the balance account may split into three sub-balances. It should be noted the number of sub-balances may vary based on the number of requests. Thus, the balance account is divided into the one or more sub-balances.

At step 308, the method 300 comprises creating a sub-container for each sub-balance. In some embodiments, each of the sub balance is stored in the sub-container.

At step 310, the method 300 comprises, redirecting the plurality of requests to access the one or more sub-balances.

The step 310 of redirecting the plurality of requests to access the one or more sub-balances comprises redirecting the plurality of request to the one or more sub-containers comprising the one or more sub-balances.

Optionally, the step 310 of redirecting the plurality of requests to access the one or more sub-balances comprises determining the sub-balance in each of the sub-container, and assigning one or more requests among the plurality of requests to each sub-container for accessing the balance account.

In some examples, the network node splits a balance B into “B1”, “B2”, “B3”. “Bm” sub-balances such that sum (Bi), i=1 . . . m equal to “B”, upon receiving “N” requests. The network node then redirects the “N” requests to the one or more sub-balances B1-Bm. In such a scenario, the throughput may increase “m” times if balance “B” is split into “m” number of sub balances. Further, if the balance account update takes one second for each request, and there are “m” sub balances, then it is possible to support “m” requests per second instead of one request per second with single balance “B”. In addition, the sub-balances may be invisible to the consumers even though the balance “B” is split into the “m” sub-balances. As a result, the consumer is able to view only the consolidated balance account.

At step 312, the method 300 comprises storing information comprising a mapping of the split of the balance account with the one or more sub-containers.

Optionally, the method 300 further comprises merging the one or more sub-balances in each of the sub-containers into a single balance account.

The sub-balances in each container are merged into a single balance account.

Optionally, the step of merging the sub-balances comprises determining the number of requests accessing the balance account. The step of merging comprises merging the sub-balances into the single balance account based on the determined number of requests.

Optionally, the step of merging the sub-balances into the single balance account comprises determining that a sub-balance in one of the sub-container is not fulfilling a required balance account for a request and merging the one or more sub-balances in each of the sub-containers, distributing the merged sub-balances to each of the sub-containers, determining whether a sub-balance in any of the sub-containers is not fulfilling a configured value of the balance account for the sub-container. When it has been determined that the sub-balance in any of the sub-containers is not fulfilling the configured value of the balance account for the sub-container, the method comprises merging the sub-balances into a single balance account within a single container.

In some examples, when one of the sub-container's balance is not fulfilling the required balance account for the request, then the existing balance from all containers are merged and distributed to all the sub-containers such that all the sub-containers has sufficient balance. If after the distribution, the balance per container is still below the configured value then all the sub-balances are merged into single balance within a single container.

Optionally, the method 300 may further comprise auto re-balancing the one or more sub-balances in the one or more sub containers based on the plurality of requests assigned to each sub-container.

Optionally, the step of auto re-balancing the one or more sub-balances in the one or more sub containers may comprise determining that at least one sub-balance from the one or more sub-balance is completely utilised by the plurality of requests and the corresponding sub-container is empty. Upon determining that at least one sub-container is empty, the method may comprise automatically re-balancing the sub-balances in the remaining containers, such that the at least one empty container has a sub-balance to be accessed by the plurality of requests, so that all sub containers can be effectively used.

FIGS. 4A-4C disclose an example implementation of the OCS for controlling access of the balance account by a plurality of requests.

As depicted in FIGS. 4A-4C, the OCS 110 comprises the OCF 108, the CHA core 106 and a Balance Management Function, BMF 104. The BMF 104 is an example of the network node 104. The BMF 104 comprises a container 204, wherein the balance account is stored. The balance account in the present example is a monetary account. In some examples, the monetary account may comprise 100 USD amount. It should be noted that the balance account may have any value of the balance. Optionally, the balance account may be a non-monetary account and may have a non-monetary balance.

Further, as depicted in FIGS. 4A-4C, there exists a Charging Trigger Function, CTF, 206 (an example entity of the wireless communication network), which decides to initiate a process of updating the balance account.

In some examples, the CTF 206 decides to initiate the process of updating the balance account, upon detecting a charging event. The CTF 206 detects the charging event by observing network resources already utilised or to be utilised by consumers. The charging event may be for example, but not limited to, sending a multimedia message, a voice call, a video call, opening a gaming application and the like. For each charging event, the CTF 206 generates and sends a request for updating the balance account in response to the network resources being used be used by the consumers. In the present example, the CTF 206 generates 8 requests namely CCR update 1-CCR update 8. The CTF 206 sends the generated CCR update 1-CCR update 8 to the OCF 108.

In some examples, the CTF 206 decides to initiate the process of updating the balance account, upon receiving the requests, for example, CCR update 1-CCR update 8, from the consumers attempting to access the balance account. In such a scenario, the CTF 206 sends the received CCR update 1-CCR update 8 to the OCF 108.

The OCF 108 connects the OCS 110 with the wireless communication network entities such as the CTF 206. In an example, the OCF 108 may send acknowledgment grants or rejection for utilisation of network resources enquired in the CCR update 1-CCR update 8 from the CTF 206 based on the processing of the CCR update 1-CCR update 8 by the BMF 104.

The OCF 108 then forwards the CCR update 1-CCR update 8 to the CHA core 106. The CHA core 106 analyses the CCR update 1-CCR update 8 and sends the CCR update 1-CCR update 8 in parallel to the BMF 104.

The BMF 104 processes each of the CCR update 1-CCR update 8 and updates the balance account.

In some examples, as depicted in FIG. 4A, for updating the balance account, the BMF 104 determines the number of requests (CCR update 1-CCR update 8) and the credit in the balance account. For instance, the credit in the balance account may be 100 USD. Also, the BMF 104 determines the average wait time interval for deducting/reserving the balance account based on the processing time of each CCR update 1-CCR update 8, the allowed wait time for processing the CCR update 1-CCR update 8, and the maximum wait time for processing of CCR update 1-CCR update 8. Based on the number of requests, the average wait time interval, the BMF 104 decides to split the balance into two sub-balances. The credit of the balance account in the container 204 is equally split into the two sub-balances. The sub-balances are stored in sub-containers SC1 204a2 and SC2 204a4. The credit in each sub balance is 50 USD. Further, as seen in FIG. 4A, the BMF 104 redirects the CCR update 1-CCR update 8 (S1-S8) to the sub-balances in the sub-containers SC1 and SC2. In some examples, the BMF 104 may redirect the CCR update 1-CCR update 8 (S1-S8) to the sub-balances in the sub-containers SC1 and SC2 using a round robin method or other similar methods known in art.

In the present example, as depicted in FIG. 4A, the request S1 (CCR update 1), S3 (CCR update 3), and S5 (CCR update 5), are assigned to the sub-container 1 and the remaining requests S2 (CCR update 2), S4 (CCR update 4), S6 (CCR update 6), S7 (CCR update 7), and S8 (CCR update 8) are assigned to the sub-container 2. The credit requested by each request is shown in the FIG. 4A. Thus, by splitting the balance account into sub-balances and redirecting the requests to different sub-balances results in parallel execution of the request. The splitting also ensures that none of the requests are rejected without processing by the BMF 104.

Further, consider that the requests S1, S3 and S8 are processed and the balance account is successfully updated, as depicted in FIG. 4B. In such a scenario, the remaining balance is USD 41 in sub-container SC1 and USD 44 in the sub-container SC2. Thus, the total remaining balance in the balance account is 85 USD.

It is to be noted that, the consumer is able to view the remaining credit of the balance account as a single balance and not as sub-balances. It is also to be noted that the consumer is able to access the balance account even though BMF redirects the requests to the sub-container(s)

In addition, the BMF 104 may further split the balance account into three sub-balances, when there is an increase in number of requests/CCR updates. As depicted in FIG. 4B, the remaining balance amount was 85 USD and credit 19 USD was reserved for the requests S2, S4, S5, S6 and S7 that have been already assigned to the sub-containers SC1 and SC2. In such a scenario, the BMF 104 splits the remaining credit (i.e., 85−19=66) equally among 3 sub-containers SC1 204a2, SC2 204a4 and SC3 204a6 (respectively). Further the credit already reserved for the requests S2, S4, S5, S6 and S7 is also seen in the sub-containers SC1 and SC2.

In some examples, the BMF 104 automatically allocates balance from multiple sub containers for a session to completely avoid balance fragmentation due to the split.

In the above example, 66$ may be the available balance/credit in total. If there is a request/CCR update for say 50$, the request cannot be served with single sub container. So the BMF 104 may allocate 36$ from SC2 and 14$ from SC3.

In some examples, when one of the sub-container's balance is not fulfilling the required balance account for the request, then the existing balance from all containers are merged and distributed to all the sub-containers such that all the sub-containers has sufficient balance. If after the distribution, the balance per container is still below the configured value then all the sub-balances are merged into single balance within a single container.

Thus, as seen in above example, concurrent processing of the requests is provided by splitting the balance account into the different sub-balances and redirecting the request to different sub-balances.

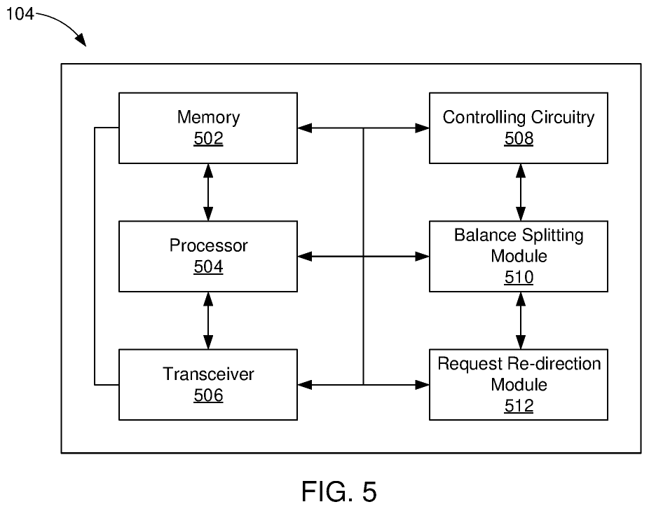

FIG. 5 is an example schematic diagram showing network node 104. The network node 104 may e.g. be the BMF 104 as seen in FIG. 5. The network node 104 is capable of controlling the balance account in the OCS system to cause parallel execution of the requests trying to access the balance account.

According to application example, the network node 104 in FIG. 5 comprises one or more modules. These modules may e.g. be a memory 502, a processor 504, a transceiver 506, a controlling circuitry 508, a balance splitting module 510, and a request redirection module 512. The controlling circuitry 508, may be adapted to control the above mentioned modules.

The memory 502, the processor 504, the transceiver 506, the balance splitting module 510, the request redirection module 512, as well as the controlling circuitry 508, may be operatively connected to each other.

The controlling circuitry 508 may be adapted to control the steps as executed by the network node. For example, the controlling circuitry 508 may be adapted to control balance account access to a balance account (as described above in conjunction with the method 300 and FIG. 3).

The transceiver 506 may be adapted to receive a plurality of requests from the consumers attempting to access the balance account.

The balance-splitting module 510 is adapted to determine whether there are a plurality of requests for accessing the balance account based on the plurality of requests received by the transceiver 506.

The balance-splitting module 510 is adapted to decide to split the balance account into one or more sub-balances upon determination that there are plurality of requests for access of the balance account.

The balance splitting module 510 may also be adapted to create one or more sub-containers with the one or more sub-balances, upon deciding that the balance account is to be split into one or more sub-balances.

The request redirection module 512 is adapted to redirect the plurality of requests to access the one or more sub-balances.

Further, the processor 504 may be adapted to determine an average wait time interval and the number of requests for splitting the balance account into the one or more sub-balances.

Furthermore, the memory 502 is adapted to store the average wait time interval, the balance account, and the one or more sub-containers.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors, DSPs, special-purpose digital logic, and the like. The processing circuitry may be configured to execute program code stored in memory, which may include one or several types of memory such as read-only memory (ROM), random-access memory, RAM, cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The foregoing description of the specific examples will so fully reveal the general nature of the solution that others can, by applying current knowledge, readily modify and/or adapt for various applications such specific examples without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

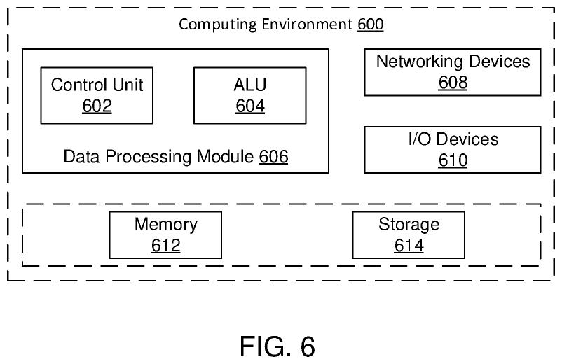

FIG. 6 illustrates an example computing environment 600 implementing a method and the network node, as described in FIGS. 3 and 5. As depicted in FIG. 6, the computing environment 600 comprises at least one data processing module 606 that is equipped with a control module 602 and an Arithmetic Logic Unit (ALU) 604, a plurality of networking devices 608, a plurality Input output, I/O devices 610, a memory 612, and a storage 614. The data processing module 606 may be responsible for implementing the method described in FIG. 3. For example, the data processing module 606 may in some embodiments be equivalent to the CPU/processor of the computing device described above in conjunction with the FIG. 3. The data processing module 606 is capable of executing software instructions stored in memory 612. The data processing module 606 receives commands from the control module 602 in order to perform its processing. Further, any logical and arithmetic operations involved in the execution of the instructions are computed with the help of the ALU 604.

The computer program is loadable into the data processing module 606, which may, for example, be comprised in an electronic network node (such as a network node). When loaded into the data processing module 606, the computer program may be stored in the memory 612 associated with or comprised in the data processing module 606. According to some embodiments, the computer program may, when loaded into and run by the data processing module 606, cause execution of method steps according to, for example, any of the method illustrated in FIG. 3 or otherwise described herein.

The overall computing environment 600 may be composed of multiple homogeneous and/or heterogeneous cores, multiple CPUs of different kinds, special media and other accelerators. Further, the plurality of data processing modules 606 may be located on a single chip or over multiple chips.

The algorithm comprising of instructions and codes required for the implementation are stored in either the memory 612 or the storage 614 or both. At the time of execution, the instructions may be fetched from the corresponding memory 612 and/or storage 614, and executed by the data processing module 606.

In case of any hardware implementations, various networking devices 608 or external I/O devices 610 may be connected to the computing environment to support the implementation through the networking devices 608 and the I/O devices 610.

The embodiments disclosed herein can be implemented through at least one software program running on at least one hardware device and performing network management functions to control the elements. The elements shown in FIG. 6 include blocks which can be at least one of a hardware device, or a combination of hardware device and software module.

1. A method for control of balance account access to a balance account, the method being performed by a network node in a wireless communication network, the method comprising:
receiving requests for accessing the balance account;
determining whether there are a plurality of requests for accessing the balance account;
upon determination that there are a plurality of requests for access of the balance account, deciding to split the balance account into one or more sub-balances; and
redirecting the plurality of requests to access the one or more sub-balances concurrently.

2. The method according to claim 1, further comprising:
creating a sub-container for each sub-balance; and
storing information comprising a mapping of the split of the balance account with the one or more sub-containers.

3. The method according to claim 1, wherein the step of deciding to split the balance account into the one or more sub-balances comprises:
obtaining an average wait time interval for deducting the balance account for each of the plurality of requests;
determining a number of requests accessing the balance account; and
deciding to split the balance account into the one or more sub-balances based on the average wait time interval and the determined number of requests.

4. The method according to claim 1, wherein the step of redirecting the plurality of requests to access the one or more sub-balances in accordance with the split of the balance account comprises:
determining the sub-balance in each of the sub-container; and
assigning one or more requests among the plurality of requests to each sub-container for accessing the balance account.

5. The method according to claim 1, further comprising:
merging the one or more sub-balances in each of the sub-containers into a single balance account.

6. The method according to claim 5, wherein the step of merging the sub-balances into the single balance account comprises:
determining the number of requests accessing the balance account; and
merging the sub-balances into the single balance account based on the determined number of requests.

7. The method according to claim 5, wherein the step of merging the sub-balances into the single balance account comprises:
determining that a sub-balance in one of the sub-container is not fulfilling a required balance account for a request;
merging the one or more sub-balances in each of the sub-containers;
distributing the merged sub-balances to each of the sub-containers;
determining whether a sub-balance in any of the sub-containers is not fulfilling a configured value of the balance account for the sub-container; and
when it has been determined that the sub-balance in any of the sub-containers is not fulfilling the configured value of the balance account for the sub-container, merging the sub-balances into a single balance account within a single container.

8. The method according to claim 1, wherein the method further comprises:
auto-rebalancing the one or more sub-balances in each of the sub-containers.

9. The method according to claim 8, wherein the step of auto-rebalancing the one or more sub-balances in each of the sub-containers further comprises:
determining that at least one sub-container, from the one or more sub-containers is empty; and
auto-rebalancing the one or more sub-balances in each of the sub-containers.

10. A network node configured to control balance account, the network node comprising a processor; and a memory storing instructions that, when executed by the processor, causes the network node to perform operations comprising:
receive requests for accessing the balance account;
determine whether there are a plurality of requests for accessing the balance account;
upon determination that there are a plurality of requests for access of the balance account, decide to split the balance account into one or more sub-balances; and
redirect the plurality of requests to access the one or more sub-balances concurrently.

11. The network node according to claim 10, wherein the operations further comprise:
create a sub-container for each sub-balance; and
store information comprising a mapping of the split of the balance account with the one or more sub-containers.

12. The network node according to claim 10, wherein the network node is configured for deciding to split the balance account into the one or more sub-balances by:
obtain an average wait time interval for deducting the balance account for each of the plurality requests;
determine a number of requests accessing the balance account; and
decide to split the balance account into the one or more sub-balances based on the average wait time interval and the determined number of requests.

13. The network node according to claim 10, wherein the network node is configured for redirecting the plurality of requests to access the one or more sub-balances in accordance with the split of the balance account by:
determine the sub-balance in each of the sub-container; and
assign one or more requests among the plurality of requests to each sub-container for accessing the balance account.

14. The network node according to claim 10, wherein the operations further comprise:
merge the one or more sub-balances in each of the sub-containers into a single balance account.

15. The network node according to claim 14, wherein the network node is configured for merging the one or more sub-balances in each of the sub-containers into a single balance account by:
determine the number of requests accessing the balance account; and
merge the sub-balances into the single balance account based on the determined number of requests.

16. The network node according to claim 14, wherein the network node is configured for merging the one or more sub-balances in each of the sub-containers into the single balance account by:
determine that a sub-balance in one of the sub-container is not fulfilling a required balance account for a request;
merge the one or more sub-balances in each of the sub-containers;
distribute the merged sub-balances to each of the sub-containers;
determine whether a sub-balance in any of the sub-containers is not fulfilling a configured value of the balance account for the sub-container; and
when it has been determined that that the sub-balance in any of the sub-containers is not fulfilling the configured value of the balance account for the sub-container, merge the sub-balances into a single balance account within a single container.

17. The network node according to claim 1, wherein the network node is further configured for auto-rebalancing the one or more sub-balances in each of the sub-containers.

18. The network node according to claim 17, wherein the network node is further configured for auto-rebalancing the one or more sub-balances in each of the sub-containers by:
determine that at least one sub-container, from the one or more sub-containers is empty; and
auto-rebalance the one or more sub-balances in each of the sub-containers.

19. An online charging system, OCS operable to provide online charging for a session, the OCS includes an online charging function, OCF, and a network node configured to control of balance account access to a balance account, the network node comprising a processor; and a memory storing instructions that, when executed by the processor causes the network node to perform operations comprising:
receive requests for accessing the balance account;
determine whether there are a plurality of requests for accessing the balance account;
upon determination that there are a plurality of requests for access of the balance account, decide to split the balance account into one or more sub-balances; and
redirect the plurality of requests to access the one or more sub-balances concurrently.

20. A computer program product comprising a non-transitory computer readable medium, having thereon a computer program comprising program instructions to be executed by processing circuitry, whereby execution of the programing instructions cause the computer program to perform operations comprising:
receive requests for accessing the balance account;
determine whether there are a plurality of requests for accessing the balance account;
upon determination that there are a plurality of requests for access of the balance account, decide to split the balance account into one or more sub-balances; and
redirect the plurality of requests to access the one or more sub-balances concurrently.
